(19) United States
(12) Patent Application Publication
(10) Pub. No.: US 2007/0102910 A1
(43) Pub. Date: May 10, 2007

(54) Air belt apparatus

(75) Inventors: Takuya Nezaki, Aichi (JP); Yoji Suyama, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/593,104

(22) Filed: Nov. 6, 2006

(30) Foreign Application Priority Data
Nov. 10, 2005 (JP) 2005-326391

(51) Int. Cl. B60R 21/18

(52) U.S. Cl. 280/733

(57) ABSTRACT

An air belt apparatus is provided wherein a gas-supplying source for operating a chest portion expansion portion and a pretensioner are mounted in limited space in a motor vehicle seat by commoditizing the gas supplying source. An air belt apparatus for use in a motor vehicle includes chest-restraint webbing having a chest expanding portion corresponding to a chest portion of an occupant at expansion, lumbar-restraint webbing being pulled out from a retractor, and corresponding to a lumbar portion of the occupant, and a gas-supplying source. Since the gas-supplying source that supplies gas to the chest expanding portion and the pretensioner are unified and commoditized, the gas supplying source can be mounted using only a limited amount of mounting space in a motor vehicle seat.

### BACKGROUND

The present invention relates to an air belt apparatus for use in a motor vehicle, provided with a chest expanding portion in a chest-restraint webbing.

An air belt apparatus, in which tensile force generated in a shoulder belt (chest-restraint webbing) when expanded is also transmitted to a lap belt (lumbar-restraint webbing), is disclosed in Unexamined Japanese Patent Application Publication No. 2000-255358 and Unexamined Japanese Patent Application Publication No. 2001-294111.

### SUMMARY OF THE INVENTION

According to one embodiment of the invention, an air belt apparatus for use in a motor vehicle includes a chest-restraint webbing having a chest expanding portion corresponding to a chest portion of an occupant at expansion, lumbar-restraint webbing to be pulled out from a retractor and corresponding to a lumbar portion of the occupant, a pretensioner for raising restraining force for the occupant at a motor vehicle collision by raising the tensile force of the lumbar-restraint webbing by gas pressure and a single gas-supplying source for supplying gas at the time of a motor vehicle collision to the chest expanding portion and the pretensioner.

According to another embodiment of the invention, an ignition electric current is transmitted to a gas supplying source when a motor vehicle collision is detected by a sensor, the gas supplying source is activated, and gas is instantaneously blown out from the gas-supplying source. The gas is promptly supplied to the chest expanding portion and the pretensioner, and the chest expanding portion is expanded by means of gas pressure corresponding to the chest portion of the occupant. Further, the pretensioner is operated to raise tensile force of the lumbar restraint webbing, and thus restraining force for the lumbar portion is raised. By expanding the chest expanding portion corresponding to the chest portion of the occupant, inertia force of the chest portion of the occupant at a front collision can be absorbed.

According to yet another embodiment of the invention, since the gas-supplying source for supplying the gas to the chest expanding portion and the pretensioner at the motor vehicle collision is unified and commoditized, the gas-supplying source can be mounted on a limited mounting space in a motor vehicle seat. According to still another embodiment of the invention, the pretensioner is disposed in the retractor.

According to another embodiment of the invention, since the pretensioner is disposed in the retractor, more mounting space is saved than when the pretensioner is provided separately from the retractor, and the tensile force of the lumbar-restraint webbing is increased at a predetermined time, upon reducing a driving loss when operating the pretensioner.

According to yet another embodiment of the invention, a gas-supplying pathway is provided for connecting the chest expanding portion and the pretensioner to the single gas-supplying source.

According to still another embodiment of the invention, since the chest expanding portion, the pretensioner and the single gas-supplying source are connected by means of the gas-supplying pathway, the gas-supplying source can be disposed at a position distant from the chest expanding portion and the pretensioner, namely at a position other than, for example, the position by the side of the seat with little mounting space. That is, since there is no need to dispose the gas-supplying source in the vicinity of the gas inlet of the chest expanding portion or in the pretensioner, the gas inlet of the chest expanding portion or the pretensioner can have a small size.

According to another embodiment of the invention, a single wire harness is connected to the single gas-supplying source, and the gas supplying source is activated through the wire harness.

According to still another embodiment of the invention, a single wire harness is connected to the single gas-supplying source, and if a collision sensor provided in the motor vehicle detects a collision, an ignition electric current is transmitted to the gas-supplying source through the wire harness. By using the single gas-supplying source and the single wire harness, parts costs and assembly costs can be reduced and the mounting space required can also be reduced.

According to another embodiment of the invention, the single gas-supplying source is disposed at a lower part of a seat cushion of a motor vehicle seat. According to yet another embodiment of the invention, since the single gas-supplying source is disposed at the lower part of the seat cushion having sufficient mounting space, in the motor vehicle seat, there is no possibility that a design of the motor vehicle seat or that of a console or the like in a circumference of the motor vehicle seat is limited by the mounting of the gas-supplying source. Accordingly, the air belt apparatus, allows for flexibility in the design of the motor vehicle seat, the console, or the like.

### BRIEF DESCRIPTION OF THE DRAWINGS

FIG. 1 is an elevation view showing an air belt apparatus for use in a motor vehicle.

FIG. 2 is an elevation view showing a condition in the air belt apparatus for use in a motor vehicle, in which a cheat portion expanding portion is expanded and tensile force of lumbar-restraint webbing is raised.

FIG. 3 is a perspective view showing chest-restraint webbing, and a retractor therefor, lumbar-restraint webbing and a retractor therefor, a tongue plate in which the chest-restraint webbing and the lumbar-restraint webbing are respectively connected, and a buckle device.

### DETAILED DESCRIPTION

Embodiments of the present invention will be described below with reference to the accompanying drawings. It should be understood that the following description is intended to describe exemplary embodiments of the invention, and not to limit the invention.

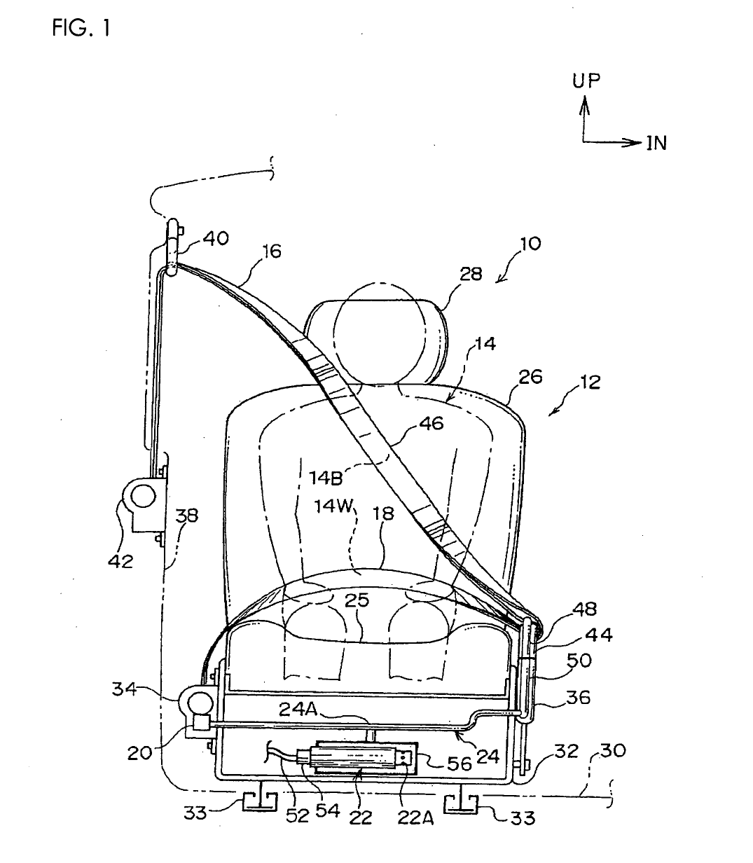

The present invention will be explained below on the basis of the drawings. In FIG. 1, an air belt apparatus 10 for use in a motor vehicle, according to one embodiment of the invention, is a kind of seat belt for restraining an occupant 14 seated in a motor vehicle seat 12. The air belt apparatus 10 for use in a motor vehicle includes chest-restraint webbing 16, lumbar-restraint webbing 18, a pretensioner 20, a gas-supplying source 22, and a gas-supplying pathway 24.

The motor vehicle seat 12 is provided with a seat cushion 25 in which a seat frame 32 is provided and the occupant 14 is seated, a seat back 26 for supporting a back of the occupant 14, and a headrest 28 provided above the seat back 26. The motor vehicle seat 12 is attached on a seat rail 33 provided on a floor panel 30 in a manner so as to be able to slide in a front-and-back direction of the motor vehicle. A retractor 34 is mounted on the seat frame 32 inside the vehicle interior on a side of the seat frame 32 adjacent to the outside of the vehicle so as to be able to swing in the front-and-back direction of the motor vehicle, and in the same manner as that of the retractor 34, a buckle apparatus 36 is mounted on the seat frame 32, inside the vehicle interior on a side of the seat frame 32 opposite to the outside of the vehicle.

According to one embodiment of the invention, the chest-restraint webbing 16 is a belt-shaped member that corresponds to a chest portion 14B of the occupant 14, and is connected to a retractor 42 disposed in a center pillar 38 via a shoulder anchor 40 provided, for example, at an upper part of the center pillar 38. The chest-restraint webbing 16 is constantly receiving tensile force applied by the retractor 42, mainly in a retracing direction for retracting the webbing 16. The chest-restraint webbing 16 can be pulled out from the retractor 42 in accordance with a body type of the occupant 14, when the air belt apparatus 10 for use in a motor vehicle is worn. A tongue plate 44 capable of being fitted with a buckle device 36 is provided at a tip end of the chest-restraint webbing 16. Further, a chest expanding portion 46 is provided in the chest-restraint webbing 16. Incidentally, the shoulder anchor 40 is not limited to that provided at a position in the center pillar 38 at a certain height, and the same may be constructed so as for the height of the portion to be adjustable.

According to one embodiment of the invention, the chest expanding portion 46 is an air belt that corresponds to the chest portion 14B of the occupant 14 when expanded. During normal operation, the chest expanding portion 46 is folded back in a manner so as to have an equivalent width as that of, for example, the chest-restraint webbing 16. In addition, a folded-back condition of the chest expanding portion 46 is retained by using a control stitching, in which a seam is ruptured in a case that internal pressure at a certain degree or more is applied thereto. In other words, the folded-back condition is retained by stitching the chest expanding portion 46 using a so-called tear seam (not shown). Thus, the chest expanding portion 46 is configured such that the tear seam is ruptured if a motor vehicle encounters a collision, and gas is k supplied into the chest expanding portion 46 from a gas-supplying source in the buckle device 36 via a portion in the vicinity of the tongue plate 44. Further, the chest expanding portion 46 is configured to be expanded to a bag-shaped condition from the folded-back condition.

According to one embodiment of the invention, the chest expanding portion 46 may overlap the chest-restraint webbing 16 that extends from the retractor 42 to the tongue plate 44. Further, the chest expanding portion 46 may be connected to an end portion of the chest-restraint webbing 16. Namely, in the chest-restraint webbing 16, a portion corresponding to the chest portion 14B of the occupant 14 may be replaced by the chest expanding portion 46. An attaching position of the retractor 42 is not limited to the center pillar 38, and the same may be set to, for example, a back face of the seat back 26 or a vehicle body portion (not shown) at a rear side of the motor vehicle seat 12.

According to one embodiment of the invention, the lumbar-restraint webbing 18 is a so-called lap belt capable of being pulled out from the retractor 34 mounted on the seat frame 32 inside the vehicle interior on a side of the seat frame 32 adjacent to the outside of the vehicle, and corresponds to a lumbar portion 14W of the occupant 14. The lumbar-restraint webbing 18 constantly receives tensile force applied by, for example, the retractor 34 mainly in a retracting direction for retracting the lumbar-restraint webbing 18, and an end portion thereof is connected to the tongue plate 44. The lumbar-restraint webbing 18 is not provided with an expanding portion, being different from the chest-restraint webbing 16.

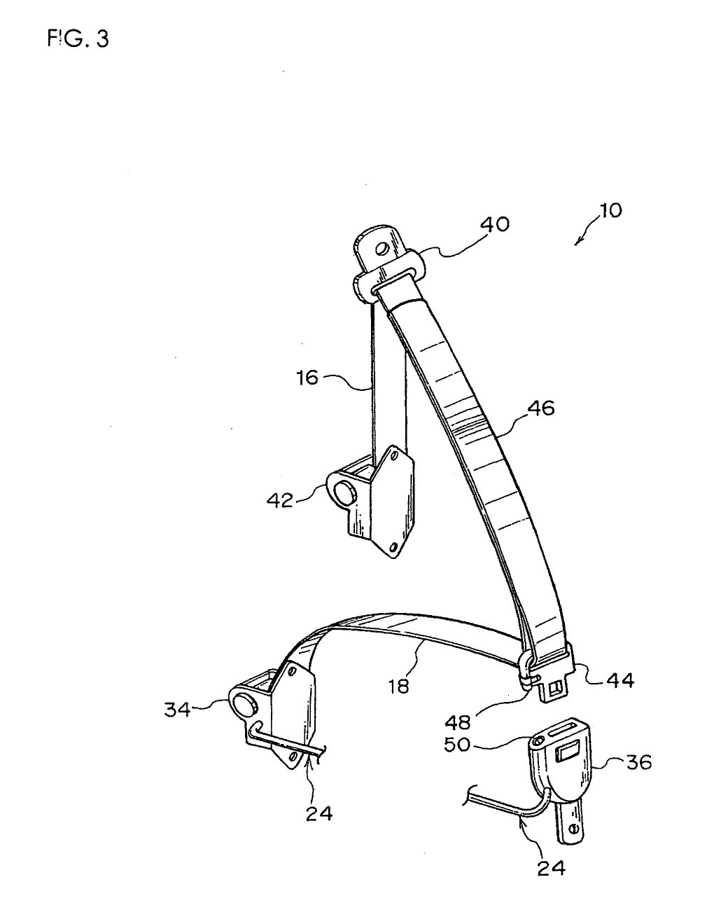

According to one embodiment of the invention, as shown in FIG. 3, a gas inlet 48 of the chest expanding portion 46 is provided in the tongue plate 44. Further, an insertion portion 50, into which the gas inlet 48 is fitted when the tongue plate 44 is fitted into the buckle device 36, is provided in the buckle device 36. A gas-supplying pathway 24 is connected to the insertion portion 50, so that the gas is supplied into the chest expanding portion 46 from the insertion portion 50 via the gas inlet 48, in a condition in which the tongue plate 44 is fitted into the buckle device 36.

According to an embodiment of the invention, as shown in FIG. 1, the pretensioner 20 is a device that raises restraining force for the lumbar portion 14W of the occupant 14 by raising tensile force of the lumbar-restraint webbing 18 by means of gas pressure, at the time of a motor vehicle collision. The pretensioner 20 is disposed in the retractor 34, and the gas is configured to be supplied into the pretensioner 20 from the gas-supplying source 22 via the gas supplying pathway 24.

According to one embodiment of the invention, the gas-supplying source 22 is a device, namely, for example, an inflator for supplying gas into the chest expanding portion 46 and the pretensioner 20. According to one embodiment of the invention, one gas-supplying source 22 is provided at a lower portion of the seat cushion 25 of the motor vehicle seat 12, namely, for example, in a case 56 installed on the seat frame 32. A gas-blowing outlet 22A of the gas-supplying source 22 is positioned in the case 56. The gas-supplying pathway 24 is connected to the case 56, and a portion other than the gas-supplying pathway 24 is sealed so that the gas is not leaked out.

According to one embodiment of the invention, a single wire harness 52 is connected to a single gas-supplying source 22 via a connector 54. When the gas is blown out from the gas-blowing outlet 22A by activating the gas-supplying source 22, the gas-supplying source 22 is configured to be activated by an ECU (not shown) through the wire harness 52.

The gas-supplying pathway 24 is a gas supplying pipe that connects the chest expanding portion 46 and the pretensioner 20, and the single gas-supplying source 22, and is connected to the case 56. According to one embodiment of the invention, the gas-supplying pathway 24 branches into two directions in a lateral direction with respect to the motor vehicle at a branching point 24A, and one branch of the gas-supplying pathway 24 is connected to the pretensioner 20, and the other branch of the gas-supplying pathway 24 is connected to the insertion portion 50 provided together in the buckle device 36, respectively.

The position of the branching point 24A is determined in consideration of operation timing for the pretensioner 20 and an expanding timing for the chest expanding portion 46. According to one embodiment of the invention, in a case that the gas is simultaneously supplied to the pretensioner 20 and the chest expanding portion 46, the position of the branching point 24A is preferably in the vicinity of a middle portion between the pretensioner 20 and the gas inlet 48. According to another embodiment of the invention, if the operation timing for the pretensioner 20 or for the chest expanding portion 46 is delayed in relation to the other, it is possible to adopt a means to form a length of the gas supplying pipe to be an uneven length or the like, by causing the position of the branching point 24A to approach a side of the pretensioner 20 or a side of a buckle device 35, or by partially folding back each of the gas-supplying pathways 24 led from the branching point 24A to the pretensioner 20 and the chest expanding portion 46, and so forth.

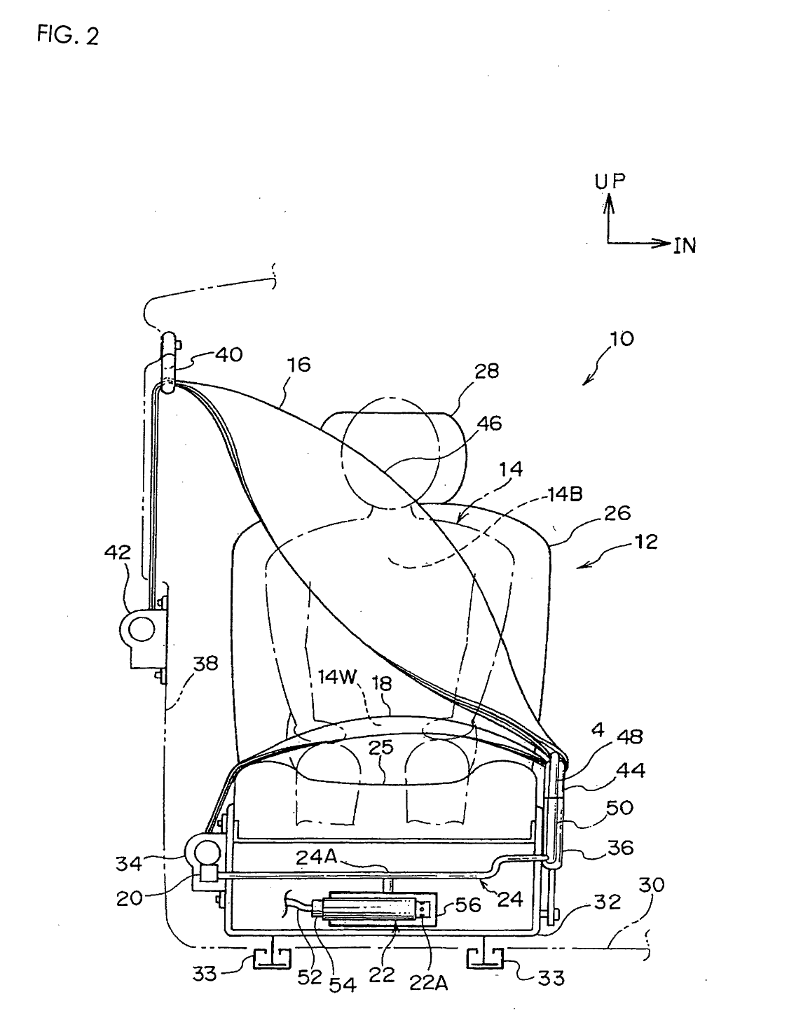

As shown in FIG. 2, in the air belt apparatus 10 for use in a motor vehicle, when a motor vehicle collision is detected by means of a sensor (not shown), an ignition electric current is transmitted from the ECU to the gas-supplying source 22, and the gas-supplying source 22 is thereby activated. Then, the gas is instantaneously blown out from the gas-blowing outlet 22A of the gas-supplying source 22 into the case 56. The gas is promptly supplied to the chest expanding portion 46 and the pretensioner 20 from the case 56 through the gas-supplying pathway 24. The chest expanding portion 46 is expanded corresponding to the chest portion 14B of the occupant 14 and the pretensioner 20 is operated by means of the gas pressure. As a result, the tensile force of the lumbar-restraint webbing 18 is increased and the restraining force for the lumbar portion 14W is thereby increased. By expanding of the chest expanding portion 46 corresponding to the chest portion 14B of the occupant 14, inertial force of the chest portion 14B of the occupant 14 generated at a front collision can be absorbed.

In the air belt apparatus 10 for use in a motor vehicle, since the gas-supplying source 22 for supplying the gas to the chest expanding portion 46 and the pretensioner 20 at a motor vehicle collision is a single gas-supplying source and is commoditized, the gas-supplying source 22 can be mounted without taking up a large amount of mounting space in the motor vehicle seat 12.

Further, since the pretensioner 20 is disposed in the retractor 34, the pretensioner 20 requires less mounting space as compared with providing the pretensioner 20 separately from the retractor 34. In addition, a driving loss occurring when operating the pretensioner 20 is reduced, and the tensile force of the lumbar-restraint webbing 18 can be increased at a predetermined timing.

According to one embodiment of the invention, since the chest expanding portion 46, the pretensioner 20, and the single gas-supplying source 22 are connected by means of the gas-supplying pathway 24, the gas-supplying source 22 can be disposed at a position distant from the chest expanding portion 46 and the pretensioner 20, namely a position other than, for example, the position by the side of the seat having a small amount of mounting space. That is, since there is no need to dispose the gas-supplying source 22 in the vicinity of the gas inlet 48 of the chest expanding portion 46, or in the pretensioner 20, the gas inlet 48 of the chest expanding portion 46 or the pretensioner 20 can have a small size.

Since the single gas-supplying source 22 and the single wire harness 52 are used, the number of parts can be decreased as compared to if a gas-supplying source 22 is respectively provided in the retractor 34 and the buckle device 36. As a result, the parts costs and assembly costs can be reduced and mounting space is saved.

Moreover, since the single gas-supplying source 22 is disposed at a lower part of the seat cushion 25 having sufficient mounting space, in the motor vehicle seat 12, there is no possibility that a design of the motor vehicle seat 12 or that of a console or the like (not shown) in a circumference of the motor vehicle seat 12 is limited by mounting of the gas-supplying source 22. Accordingly, in a case that the air belt apparatus 10 for use in a motor vehicle is mounted on a motor vehicle, flexibility of the design of the motor vehicle seat 12, the console, or the like, can be maintained.

Incidentally, in the aforementioned embodiment, although the mounting position of the single gas-supplying source 22 is set to the lower part of the seat cushion 25, the single gas-supplying source 22 may be provided at a portion having sufficient mounting space, other than the above-described, without being limited to a lower part of the seat cushion in the air belt apparatus for use in a motor vehicle.

In addition to the aforementioned hitherto known example, it is possible to provide a pretensioner for raising the tensile force of the lumbar-restraint webbing at a collision. However, when a gas-supplying source for the pretensioner and that for a chest expanding portion are separately mounted on a motor vehicle seat in a case that the pretensioner is operated by means of gas pressure from a gas-supplying source, much mounting space for mounting the gas-supplying sources is required. In particular, when the gas-supplying sources are mounted by the side of a seat, there is a possibility that sufficient mounting space cannot be secured.

The above described air belt apparatus has several advantages. For example, by mounting the pretensioner with the retractor a significant amount of mounting space is saved in comparison with mounting the pretensioner separately from the retractor. In addition, the tensile force of the lumbar-restraint webbing can be raised at a predetermined time.

Further, since the gas-supplying source can be disposed at a position distant from the chest expanding portion and the pretensioner, namely at a position other than, for example, the position by the side of the seat having little mounting space, and since there is no need to dispose the gas-supplying source in the vicinity of the gas inlet of the chest expanding portion, or in the pretensioner, the gas inlet of the chest expanding portion or the pretensioner can be small. In addition parts costs and assembly costs is reduced, and the required mounting space is also reduced.

In addition, another advantage is that the design of the motor vehicle seat, the console or the like in a circumference of the motor vehicle seat is not limited by the mounting of the gas-supplying source. Therefore, the flexibility of the design of the motor vehicle seat, the console, or the like can be maintained. Accordingly, an object of the present invention is to enable the gas-supplying source for operating the chest expanding portion and the pretensioner, to be mounted on a limited mounting space in the motor vehicle seat by commoditizing the gas-supplying source.

Japan Priority Application 2005-326391, filed Nov. 10, 2005 including the specification, drawings, claims and abstract, is incorporated herein by reference in its entirety.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. An air belt apparatus for use in a motor vehicle comprising:
chest-restraint webbing having a chest expanding portion corresponding to a chest portion of an occupant at expansion;
lumbar-restraint webbing to be pulled out from a retractor and corresponding to a lumbar portion of the occupant;
a pretensioner for raising restraining force for the occupant by raising tensile force of the lumbar-restraint webbing by means of gas pressure at a motor vehicle collision; and
a single gas-supplying source for supplying gas to the chest expanding portion and the pretensioner at the motor vehicle collision.

2. The air belt apparatus for use in a motor vehicle according to claim 1, wherein the pretensioner is disposed in the retractor.

3. The air belt apparatus for use in a motor vehicle according to claim 1, wherein a gas-supplying pathway is provided for connecting the chest expanding portion and the pretensioner to the single gas-supplying source.

4. The air belt apparatus for use in a motor vehicle according to claim 1, wherein a single wire harness is connected to the single gas-supplying source, and the gas supplying source is activated through the wire harness.

5. The air belt apparatus for use in a motor vehicle according to claim 1, wherein the single gas-supplying source is disposed at a lower part of a seat cushion of a motor vehicle seat.

6. The air belt apparatus for use in a motor vehicle according to claim 3, wherein the chest-restraint webbing has a tongue plate provided at the end of the chest-restraint webbing for connecting to a buckle device, wherein a gas inlet is provided in the tongue plate.

7. The air belt apparatus for use in a motor vehicle according to claim 6, wherein the buckle device has an insertion portion configured to receive the gas inlet, wherein the gas-supplying pathway is connected to the insertion portion.

8. The air belt apparatus for use in a motor vehicle according to claim 6, wherein the gas-supplying pathway branches at a branching point such that a first branch of the gas-supplying pathway is connected to the pretensioner and a second branch of the gas-supplying pathway is connected to the insertion portion.

9. An air belt apparatus comprising:
a chest-restraint webbing having an expandable portion configured to expand in an area near the chest of an occupant;
a lumbar-restraint webbing configured to emerge from a retractor;
a pretensioner configured to increase the tensile force applied by the lumbar-restraint webbing; and
a gas source configured to supply gas to the chest-restraint webbing and the pretensioner.

10. The air belt apparatus according to claim 9, wherein the pretensioner is disposed in the retractor.

11. The air belt apparatus according to claim 9, wherein the gas source is connected to the chest-restraint webbing and the pretensioner via a gas-supply pathway.

12. The air belt apparatus according to claim 9, wherein the gas source is connected to a single wire harness that activates the gas source.

13. The air belt apparatus according to claim 9, wherein the gas source is disposed underneath a lower part of a seat in a motor vehicle.

14. The air belt apparatus according to claim 11, wherein the chest-restraint webbing has a tongue plate provided at the end of the chest-restraint webbing for connecting to a buckle device, wherein a gas inlet is provided in the tongue plate.

15. The air belt apparatus according to claim 14, wherein the buckle device has an insertion portion configured to receive the gas inlet, and the gas-supply pathway is connected to the insertion portion.

16. The air belt apparatus for use in a motor vehicle according to claim 15, wherein the gas-supply pathway branches at a branching point such that a first branch of the gas-supply pathway is connected to the pretensioner and a second branch of the gas-supply pathway is connected to the insertion portion.

17. An air belt apparatus comprising:
a chest-restraint webbing having an expandable portion configured to expand in an area near the chest of an occupant;
a lumbar-restraint webbing configured to emerge from a retractor;
a pretensioner configured to increase the tensile force applied by the lumbar-restraint webbing; and
a gas source configured to supply gas to the chest-restraint webbing and the pretensioner, wherein the gas source is connected to the chest-restraint webbing and the pretensioner via a gas-supply pathway that branches at a branching point such that a first branch of the gas-supply pathway is connected to the pretensioner and a second branch of the gas-supply pathway is connected to the chest-restraint webbing.

18. The air belt apparatus according to claim 17, wherein the pretensioner is disposed in the retractor.

19. The air belt apparatus according to claim 17, wherein the gas source is connected to the chest-restraint webbing and the pretensioner via a gas-supply pathway.

20. The air belt apparatus according to claim 17, wherein the gas source is connected to a single wire harness that activates the gas source.
